(19) United States
(12) Patent Application Publication
(10) Pub. No.: US 2025/0276326 A1
(43) Pub. Date: Sep. 4, 2025

(54) Strand Pelletizer

(71) Applicant: Maag Germany GmbH, Grossostheim (DE)

(72) Inventors: Stefan Dahlheimer, Kleinostheim (DE); Matthias Namyslo, Aschaffenburg (DE)

(21) Appl. No.: 18/990,939

(22) Filed: Dec. 20, 2024

(30) Foreign Application Priority Data
Feb. 29, 2024 (DE) 10 2024 105 741.6

(51) Int. Cl. B02C 25/00; B02C 18/14

(52) U.S. Cl. CPC B02C 25/00; B02C 18/144; B02C 18/148

(57) ABSTRACT

A strand pelletizer for pelletizing strands such as strands of plastic material into pellets, having a cutting mechanism which has a rotationally drivable cutting rotor and a stationary counter-knife cooperating therewith, wherein a cutting gap is formed between a cutting edge of the stationary counter-knife and rotor tooth tips of the cutting rotor. During operation of the cutting mechanism on the stationary counter-knife there is provided at least one sensor for determining a gap dimension of the cutting gap.

### CROSS-REFERENCE TO RELATED APPLICATIONS

This application claims benefit under 35 USC § 119 of DE Application No. 10 2024 105 741.6 filed 29 Feb. 2024, which is incorporated herein by reference in its entirety as if set forth herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The present invention generally relates to pelletizing, and more particularly to a cutting mechanism for a pelletizer, and a strand pelletizer for pelletizing strands such as strands of plastic material into pellets with the cutting mechanism.

### 2. Description of Related Art

Conventional strand pelletizers are usually used for pelletizing strands of plastic material, which are produced by means of a caster and a corresponding nozzle plate and fed to the strand pelletizer—depending on the setting or specific process together with the cooling water—via a drainage trough, cf. for example DE 31 45 613 A1, EP 0 079 609 A1 or U.S. Pat. No. 4,528,157 B1. By means of such strand pelletizers, which can also perform a dry cut, other materials such as food in the form of pasta strands or pharmaceutically active material strands can also be granulated into tablets. By feeding several strands side by side in parallel to the cutting mechanism, there can be achieved high throughput rates.

In this regard, the cutting mechanism comprises a rotationally drivable cutting rotor, which can have rib-shaped or strip-shaped cutting projections or rotor teeth on its circumferential surface, which interact with a stationary counter-knife. The counter-knife can substantially consist of a cutting strip that is positioned adjacent to the circumference of the cutting rotor so that the passing, strip-shaped projections or rotor teeth of the cutting rotor can cut the strands of plastic material on the counter-knife.

In order to be able to feed the strands in controlled alignment and speed to the working area of the cutting mechanism, i.e., the area between the counter-knife and cutting rotor in controlled alignment and speed, a feed device is connected upstream of the cutting mechanism, which has feed rollers rotating in opposite directions, between which the strands are conveyed in order to be fed onto the cutting mechanism.

Such cutting mechanisms having a pair of feed rollers are known, for example, from the DE 101 06 677 C1, DE 34 26 316 A1, DE 31 45 613 A1 and DE 26 00 078 A1.

In order to achieve a high-quality cut of the strands of plastic material and to make the cutting process efficient, the cutting gap between the rotor teeth of the cutting rotor and the cutting edge of the counter-knife must be very small and very precisely adjusted, wherein the cutting gap should also be as large or small as possible over the length of the cutting rotor and counter-knife. If the cutting gap is too large, the often viscoplastic or sticky strands are not sheared cleanly and do not have clean cutting edges. In addition, the load on the cutting mechanism increases significantly, as strand material can be sheared between the rotor tooth tips and the cutting edge of the counter-knife, which can lead to increased bearing loads, vibrations and an increased power requirement.

Conversely, if the cutting gap is set too small, there is a risk of direct mechanical contact between the rotor tooth tips and the counter-knife if, for example, the originally very small cutting gap is further reduced due to thermal loads and the resulting deformations.

As the cutting gap, as already mentioned, should be very small but not too small, setting the cutting gap on strand pelletizers is very difficult and cannot be done perfectly even with a lot of experience, as the influences on the cutting gap that occur during operation, such as thermal expansion processes and different strand materials, are difficult to estimate, especially during the start-up process of the strand pelletizer.

The cutting gap on strand pelletizers is usually measured manually with the machine stationary using so-called spy plates, which are available in very fine gradations, for example in thicknesses of one hundredth of a mm, so that the cutting gap between the cutting rotor and counter-knife can be precisely adjusted in the 1/100 mm range.

Nevertheless, it is difficult to set the cutting gap correctly due to the dynamic changes during the approach process. Due to the influence of the hot strands and/or the process water temperature used in each case, the cutting gap changes when the machine starts up, with a corresponding negative effect on the cutting process. Depending on the process, the gap can become larger or smaller, for example when using cold or hot process water, wherein this process is dynamic. The change occurs until a steady state is reached, wherein in the extreme case the cutting rotor can run up against the counter-blade and cause corresponding damage.

In order to get a grip on these dynamic changes, attempts are made to carry out cutting gap measurements at short intervals in order to recognize what happens to the cutting gap under the given process conditions. However, this is both time-consuming and relatively inaccurate, as the machine cools down very quickly after being switched off and the temperatures change again, so that measurements have to be taken very quickly. In fact, as soon as the machine is stopped and the cutting head is opened, the gap changes again.

Therefore, the object of the present invention is to provide an improved strand pelletizer of the type mentioned, which avoids disadvantages of the prior art and advantageously improves the latter. In particular, an improved adjustment of the cutting gap is to be achieved, which can better take into account dynamic changes due to temperature changes, for example.

### BRIEF SUMMARY OF THE INVENTION

In an exemplary embodiment of the present invention, a strand pelletizer for granulating strands such as strands of plastic material into pellets comprises a cutting mechanism that has a rotationally drivable cutting rotor and a counter-knife cooperating therewith, wherein a cutting gap is formed between a cutting edge of the counter-knife and rotor tooth tips of the cutting rotor, wherein at least one sensor is provided on the stationary counter-knife for determining the gap dimension of the cutting gap during operation of the cutting mechanism.

It is therefore proposed to measure the cutting gap between the cutting rotor and the counter-knife during operation, i.e., when the cutting rotor is running and/or when the strands are being cut, and to use a suitable sensor system for this purpose. According to the invention, during operation of the cutting mechanism on the stationary counter-knife there is provided at least one sensor, so as to determine the cutting gap. By means of the at least one sensor operating in cutting mode, there can be detected or monitored changes in the cutting gap during operation and, in particular, dynamic changes in the cutting gap during the start-up process. Knowledge of the dynamic behavior of the cutting gap makes it possible to set the gap dimension to an optimum value that ensures a high-quality cut on the one hand and avoids the risk of the cutting rotor running up against the counter-knife on the other.

In a further development of the invention, the at least one sensor is positioned in the immediate vicinity or immediate neighborhood of the cutting edge of the counter-knife in order to be able to detect cutting gap changes as directly as possible.

In particular, the at least one sensor can be rigidly attached to the counter-knife so that the sensor follows or experiences changes in the distance of the counter-knife from the strand rotor in the same way as the counter-knife.

In particular, the at least one sensor can be arranged at least partially recessed in the counter-knife and, in relation to the direction of rotation of the cutting rotor, can be arranged behind or downstream of the cutting edge of the counter-knife and thereby look onto the rotor teeth passing past the counter-knife. Preferably, the at least one sensor can be placed directly under the cutting edge of the counter-knife, wherein “under” means that the cutting edge itself protrudes slightly, for example in the manner of a roof protrusion, over the sensor towards the cutting rotor and a passing rotor tooth first brushes past the cutting edge itself and then past the sensor.

The sensor can be arranged on the counter-knife, for example, in such a way that the sensor is directly opposite a rotor tooth of the cutting rotor when the rotor tooth has traveled an angle of rotation of less than 20° or less than 10° or less than 5°, relative to the cutting rotor position in which the rotor tooth is exactly at the cutting edge of the counter-knife with its rotor tooth tip.

The at least one sensor can advantageously be configured to detect the passing rotor tooth tips of the cutting rotor, in particular the distance from the rotor tooth tips.

The at least one sensor is advantageously a non-contact distance sensor. In particular, the sensor can be configured in the form of an eddy current sensor.

Such an eddy current sensor makes it possible to determine the distance to the conductive rotor tooth tips, which can be configured from steel or another conductive alloy, for example. Advantageously, non-conductive media such as water or coolant and the material of the strands of plastic material, for example, have no influence on the measurement result with such an eddy current sensor.

In order to be able to detect the rotor tooth tips, which usually pass by very quickly, with sufficient accuracy, the at least one sensor can be operated with a relatively high sampling frequency, which in a further development of the invention can be more than 2 kHz or more than 5 kHz or even more than 10 kHz or more than 30 kHz.

In an advantageous further development of the invention, several sensors are arranged distributed along the cutting gap in order to be able to measure the cutting gap in different portions of the cutting mechanism. This means that uneven dynamic changes in the cutting gap across the width can also be precisely detected, for example if the central portion is fed more heavily there than at the edges to the right and left of the cutting mechanism.

In another exemplary embodiment of the present invention, a cutting mechanism comprises a rotationally drivable cutting rotor with rotor tooth tips, a counter-knife with a cutting edge, and a sensor system, wherein a cutting gap is formed between the cutting edge of the counter-knife and the rotor tooth tips of the cutting rotor, and the sensor system is configured to determine a gap dimension of the cutting gap during operation of the cutting mechanism.

The sensor system can comprise a gap sensor provided on the counter-knife.

The counter-knife can be a stationary counter-knife.

The gap sensor can be configured as a sensor selected from the group consisting of a non-contact measuring distance sensor and an eddy current sensor.

The sensor system can comprise a sensor that at least one of is directed towards the passing rotor tooth tips of the rotationally drivable cutting rotor, detects a spacing of the passing rotor tooth tips from a sensor head of the sensor, or detects a spacing of the passing rotor tooth tips from the counter-knife.

The sensor system can comprise a sensor arranged at least partially recessed in the counter-knife, and behind the cutting edge of the counter-knife with respect to a direction of rotation of the rotationally drivable cutting rotor and faces the rotationally drivable cutting rotor.

The sensor system can comprise a sensor arranged at a flank portion of the counter-knife that is reached by a rotor tooth with an angle of rotation of less than 20° with respect to the rotationally drivable cutting rotor position in which the rotor tooth lies with its rotor tooth tip exactly at the cutting edge of the counter-knife.

The sensor system can comprise a sensor arranged at a flank portion of the counter-knife that is reached by a rotor tooth with an angle of rotation of less than 5° with respect to the rotationally drivable cutting rotor position in which the rotor tooth lies with its rotor tooth tip exactly at the cutting edge of the counter-knife.

The sensor system can comprise a sensor having a sampling frequency of more than 2 kHz. The sensor system can comprise a sensor having a sampling frequency of more than 30 kHz.

In another exemplary embodiment of the present invention, a strand pelletizer comprises a cutting mechanism comprising a rotationally drivable cutting rotor with rotor tooth tips, a stationary counter-knife with a cutting edge, and a sensor system comprising a gap sensor provided on the stationary counter-knife, wherein a cutting gap is formed between the cutting edge of the stationary counter-knife and the rotor tooth tips of the cutting rotor, and the gap sensor is configured to determine a gap dimension of the cutting gap during operation of the cutting mechanism.

The sensor system can comprise sensors distributed over the length of the cutting gap and mounted on the stationary counter-knife.

The strand pelletizer can further comprise a cutting gap adjustment apparatus configured to adjust the gap dimension of the cutting gap during operation of the cutting mechanism, wherein the cutting gap adjustment apparatus comprises a feed device for at least one of feeding the rotationally drivable cutting rotor towards and away from the stationary counter-knife, or feeding the stationary counter-knife towards and away from the rotationally drivable cutting rotor.

The feed device can comprise an adjustment drive, and a control device configured to control the adjustment drive to adjust the cutting gap during operation of the cutting mechanism depending on a signal from one or more sensors of the sensor system.

These and other objects, features and advantages of the present invention will become more apparent upon reading the following specification in conjunction with the accompanying drawing figures.

### BRIEF DESCRIPTION OF THE DRAWINGS

The accompanying Figures, which are incorporated in and constitute a part of this specification, illustrate several aspects described below.

FIG. 1 is a a perspective, partially free-cut side view of a strand pelletizer according to an advantageous embodiment of the invention, wherein there can be seen the cutting mechanism of the strand pelletizer comprising a cutting rotor and a counter-knife as well as a feed device connected upstream of the cutting mechanism and comprising a pair of feed rollers rotating in opposite directions.

FIG. 2 is a partial cross-sectional view of the cutting mechanism and the upstream feed rollers, wherein there is shown a distance sensor provided under the cutting edge of the counter-knife for detecting the cutting gap dimension.

FIG. 3 is an enlarged partial cross-sectional view of the sensor from FIG. 2, which is recessed in the counter-knife, showing its position in the counter-knife and relative to the rotor tooth tips of the cutting rotor.

### DETAIL DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

As the figures show, the strand pelletizer 1 comprises a cutting mechanism 2 which has a rotationally drivable cutting rotor 3 to which a counter-knife 4 is assigned, so that strands entering the cutting mechanism 2, such as thermoplastic strands of plastic material, can be cut or sheared off by the cutting knife 2 at the counter-knife 4.

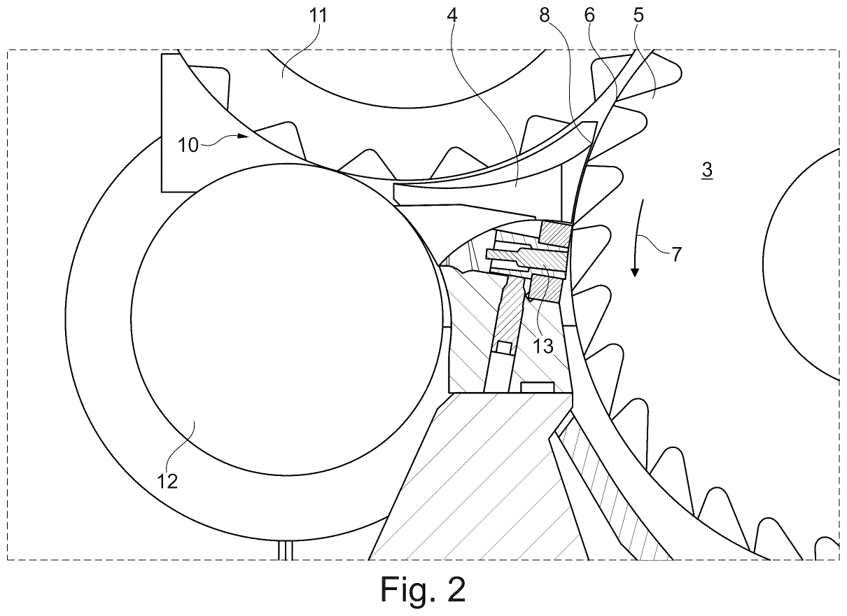

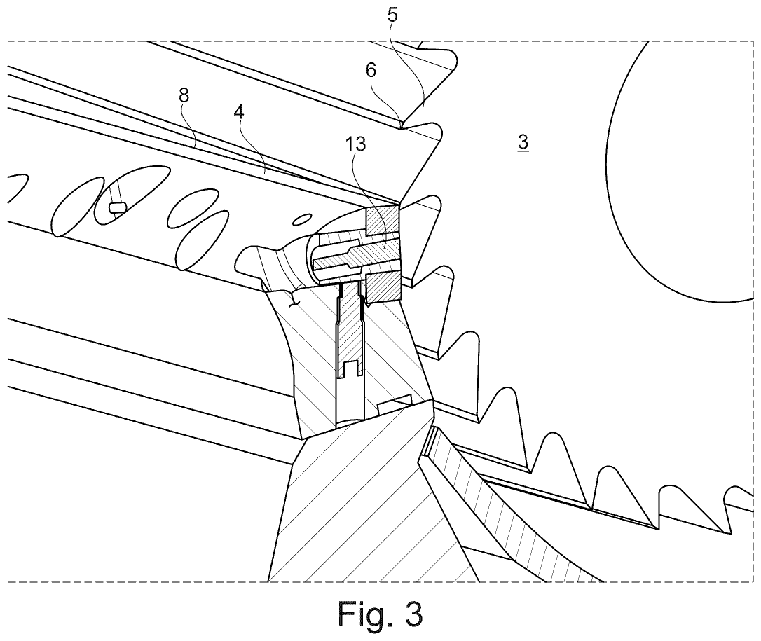

In a manner known per se, the cutting rotor 3 has peripheral cutting projections or rotor teeth 5, which can be configured in the form of strips and extend substantially over the entire length of the cutting rotor 3. In this respect the cutting projections or rotor teeth 5 may be arranged substantially parallel to the longitudinal axis of the roller of the cutting rotor 3, but may also extend at an angle thereto or extend slightly helically along the cylindrical enveloping surface of the cutting rotor 3. In this respect, the rotor teeth, viewed in cross-section, can be configured to be acute overall and/or inclined with respect to the radial direction, so that the tooth tips look slightly forward at an angle with respect to the direction of rotation 7 of the cutting rotor 3 in order to be able to “bite” into the strands, cf. FIG. 2 and FIG. 3.

The counter-knife is arranged on the enveloping surface of the cutting rotor 3 and can be configured in the shape of a strip or form a web-shaped blade, against which the cutting knife 2 passes with its rotor teeth 5. In particular, the counter-knife 3 can have a cutting edge 8 that extends along the enveloping surface of the cutting rotor 3, in particular parallel to the axis of rotation of the cutting rotor 3, and can be undercut or “sharpened” at a slightly acute edge angle, cf. FIG. 2.

Between the cutting edge 8 of the counter-knife 4 and the tooth tips 6 of the rotor teeth 5 of the cutting rotor 3 there is defined a cutting gap, the gap dimension of which can be in the range of a few hundredths of a mm.

In order to feed the strands to be cut, such as thermoplastic strands of plastic material or food strands, to the cutting mechanism 2 at a controlled speed and in a controlled direction, a feed device 10 is connected upstream of the cutting mechanism 2, which comprises two feed rollers 11, 12 rotating in opposite directions to convey the strands between them and towards the cutting mechanism 2. As shown in FIG. 2, the counter-knife 4 is located in the delivery area of the feed rollers 11, 12 and is arranged between the feed rollers 11, 12 and the cutting rotor 3.

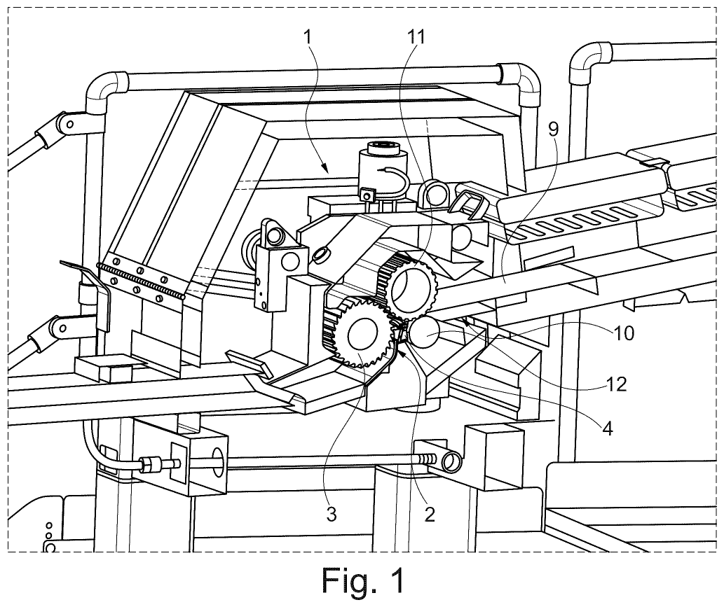

The strands to be pelletized, which can come from a continuous caster, can reach the feed device 2 by means of a conveying device such as a drainage trough 9, cf. FIG. 1, as is known per se.

In order to be able to determine the gap dimension of the cutting gap between the cutting edge 8 of the counter-knife 4 and the tooth tips 6 of the cutting rotor 3 even during operation of the cutting mechanism 2, a sensor system is assigned to the cutting mechanism 2, which has at least one sensor 13, which is provided on the stationary counter-knife 4, cf. FIG. 2 and FIG. 3. Advantageously, several sensors 13 can be arranged distributed over the length of the cutting gap in order to be able to determine the gap dimension in different portions of the cutting mechanism 2.

As FIGS. 2 and 3 show, the sensor 13 is advantageously mounted on the counter-knife 4 in the immediate vicinity of the cutting edge 8, so that the sensor 13 follows changes in the distance of the counter-knife 4 from the cutting rotor 3. In particular, the at least one sensor 13 is positioned, in relation to the direction of rotation 7 of the cutting rotor 3, directly behind or downstream of the cutting edge 8 on a portion of the counter-knife 4 that a respective rotor tooth 5 reaches after it has passed the cutting edge 8.

As FIGS. 2 and 3 show, the sensor 13 can advantageously be arranged at least partially recessed in the counter-knife 3, wherein the counter-knife 4 can, for example, have a bore open towards the cutting rotor 3, for example in the form of a blind hole, in which the sensor can be arranged recessed. If the sensor is fitted with a data cable, a through-hole or cross-hole can also be provided in the counter-knife to lead the cable out. However, the sensor can also have a wireless data transmission module, for example with a Bluetooth or radio interface.

The sensor 13 can be directed with its sensor head towards the rotor teeth 5 passing by, wherein the sensor head can be arranged exposed or flush with the counter blade flank facing the cutting rotor 3, cf. FIGS. 2 and 3.

The sensor 13 is advantageously configured as a non-contact distance sensor, in particular in the form of an eddy current sensor, which can detect the distance of the sensor head and thus of the counter-knife 4 from the tooth tips 6 of the rotor teeth 5 passing by. The sensor head of the sensor 13 generates an eddy current field directed towards the rotor teeth 5, which is affected by the ferromagnetic rotor teeth depending on their distance from the sensor head, so that the sensor 13 can provide a sensor signal characterizing the distance.

Advantageously, the sensor 13 operates with a sufficiently high sampling frequency of more than 5 kHz or more than 100 kHz, for example, in order to be able to precisely detect the very fast rushing tooth tips 6.

Advantageously, the gap dimension of the cutting gap measured online can be used to set the gap dimension appropriately by adjusting the position of the cutting rotor 3 and/or counter-knife 4, which can advantageously also be carried out during operation of the cutting mechanism, but possibly also in the stopped state, wherein a feed device with an adjustment drive can be controlled by a control device depending on the signal of the sensor 13 in order to move the cutting rotor 3 closer to or further away from the counter-knife 4, wherein the counter-knife 4 can also be moved accordingly if necessary.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A cutting mechanism comprising:
a rotationally drivable cutting rotor with rotor tooth tips;
a counter-knife with a cutting edge; and
a sensor system;
wherein:
a cutting gap is formed between the cutting edge of the counter-knife and the rotor tooth tips of the cutting rotor; and
the sensor system is configured to determine a gap dimension of the cutting gap during operation of the cutting mechanism.

2. The cutting mechanism of claim 1, wherein:
the sensor system comprises a gap sensor; and
the gap sensor is provided on the counter-knife.

3. The cutting mechanism of claim 1, wherein the counter-knife is a stationary counter-knife.

4. The cutting mechanism of claim 2, wherein the gap sensor is configured as a sensor selected from the group consisting of a non-contact measuring distance sensor and an eddy current sensor.

5. A strand pelletizer comprising the cutting mechanism of claim 1.

6. The strand pelletizer of claim 5, wherein:
the sensor system comprises a gap sensor; and
the gap sensor is arranged in the immediate vicinity of the cutting edge of the counter-knife.

7. The strand pelletizer of claim 5, wherein the sensor system comprises a sensor that at least one of:
is directed towards the passing rotor tooth tips of the rotationally drivable cutting rotor;
detects a spacing of the passing rotor tooth tips from a sensor head of the sensor; or
detects a spacing of the passing rotor tooth tips from the counter-knife.

8. The strand pelletizer of claim 5, wherein the sensor system comprises a sensor arranged:
at least partially recessed in the counter-knife; and
behind the cutting edge of the counter-knife with respect to a direction of rotation of the rotationally drivable cutting rotor and faces the rotationally drivable cutting rotor.

9. The strand pelletizer of claim 5, wherein the sensor system comprises a sensor arranged at a flank portion of the counter-knife that is reached by a rotor tooth with an angle of rotation of less than 20° with respect to the rotationally drivable cutting rotor position in which the rotor tooth lies with its rotor tooth tip exactly at the cutting edge of the counter-knife.

10. The strand pelletizer of claim 5, wherein the sensor system comprises a sensor arranged at a flank portion of the counter-knife that is reached by a rotor tooth with an angle of rotation of less than 5° with respect to the rotationally drivable cutting rotor position in which the rotor tooth lies with its rotor tooth tip exactly at the cutting edge of the counter-knife.

11. The strand pelletizer of claim 5, wherein the sensor system comprises a sensor having a sampling frequency of more than 2 kHz.

12. The strand pelletizer of claim 5, wherein the sensor system comprises a sensor having a sampling frequency of more than 30 KHz.

13. A strand pelletizer comprising:
a cutting mechanism comprising:
a rotationally drivable cutting rotor with rotor tooth tips;
a stationary counter-knife with a cutting edge; and
a sensor system comprising a gap sensor provided on the stationary counter-knife;
wherein:
a cutting gap is formed between the cutting edge of the stationary counter-knife and the rotor tooth tips of the cutting rotor; and
the gap sensor is configured to determine a gap dimension of the cutting gap during operation of the cutting mechanism.

14. The strand pelletizer of claim 13, wherein the gap sensor is arranged in the immediate vicinity of the cutting edge of the stationary counter-knife.

15. The strand pelletizer of claim 13, wherein the gap sensor at least one of:
is directed towards the passing rotor tooth tips of the rotationally drivable cutting rotor;
detects a spacing of the passing rotor tooth tips from a sensor head of the sensor; or
detects a spacing of the passing rotor tooth tips from the stationary counter-knife.

16. The strand pelletizer of claim 13, wherein the gap sensor is arranged:
at least partially recessed in the stationary counter-knife; and
behind the cutting edge of the stationary counter-knife with respect to a direction of rotation of the rotationally drivable cutting rotor and faces the rotationally drivable cutting rotor.

17. The strand pelletizer of claim 13, wherein the gap sensor is arranged at a flank portion of the stationary counter-knife that is reached by a rotor tooth with an angle of rotation of less than 20° with respect to the rotationally drivable cutting rotor position in which the rotor tooth lies with its rotor tooth tip exactly at the cutting edge of the stationary counter-knife.

18. The strand pelletizer of claim 13, wherein the gap sensor is arranged at a flank portion of the stationary counter-knife that is reached by a rotor tooth with an angle of rotation of less than 5° with respect to the rotationally drivable cutting rotor position in which the rotor tooth lies with its rotor tooth tip exactly at the cutting edge of the stationary counter-knife.

19. The strand pelletizer of claim 13, wherein the gap sensor has a sampling frequency of more than 2 kHz.

20. The strand pelletizer of claim 13, wherein the gap sensor has a sampling frequency of more than 30 kHz.

21. The strand pelletizer of claim 13, wherein the sensor system comprises sensors distributed over the length of the cutting gap and mounted on the stationary counter-knife.

22. The strand pelletizer of claim 13 further comprising a cutting gap adjustment apparatus configured to adjust the gap dimension of the cutting gap during operation of the cutting mechanism;
wherein the cutting gap adjustment apparatus comprises a feed device for at least one of:
feeding the rotationally drivable cutting rotor towards and away from the stationary counter-knife; or
feeding the stationary counter-knife towards and away from the rotationally drivable cutting rotor.

23. The strand pelletizer of claim 22, wherein the feed device comprises:
an adjustment drive; and
a control device configured to control the adjustment drive to adjust the cutting gap during operation of the cutting mechanism depending on a signal from one or more sensors of the sensor system.
